(19) United States
(12) Patent Application Publication
(10) Pub. No.: US 2016/0131530 A1
(43) Pub. Date: May 12, 2016

(54) PYROELECTRIC BODY, PYROELECTRIC ELEMENT, PRODUCTION METHOD FOR PYROELECTRIC ELEMENT, THERMOELECTRIC CONVERSION ELEMENT, PRODUCTION METHOD FOR THERMOELECTRIC CONVERSION ELEMENT, THERMAL PHOTODETECTOR, PRODUCTION METHOD FOR THERMAL PHOTODETECTOR, AND ELECTRONIC APPARATUS

(71) Applicant: Seiko Epson Corporation, Tokyo (JP)

(72) Inventor: Yasushi TSUCHIYA, Fujimi (JP)

(21) Appl. No.: 14/932,216

(22) Filed: Nov. 4, 2015

(30) Foreign Application Priority Data
Nov. 10, 2014 (JP) 2014-228304

(51) Int. Cl. G01J 5/02; C01G 49/00

(52) U.S. Cl. CPC G01J 5/02; C01G 49/009; C01P 2006/40; C01P 2002/34

(57) ABSTRACT

A pyroelectric body includes an oxide containing iron, manganese, bismuth, and gadolinium, wherein the oxide has a perovskite-type crystal structure, and in the oxide, the ratio of the number of atoms of gadolinium to the total number of atoms of A-site elements is 8.0 at % or more and 18 at % or less. In the oxide, the ratio of the number of atoms of manganese to the total number of atoms of B-site elements is preferably 1.0 at % or more and 2.0 at % or less. In the oxide, the ratio of the number of atoms of titanium to the total number of atoms of B-site elements is preferably 0 at % or more and 4.0 at % or less. The pyroelectric body is preferably used at an environmental temperature in the range of −40° C. or higher and 40° C. or lower.

### BACKGROUND

1. Technical Field

The present invention relates to a pyroelectric body, a pyroelectric element, a production method for a pyroelectric element, a thermoelectric conversion element, a production method for a thermoelectric conversion element, a thermal photodetector, a production method for a thermal photodetector, and an electronic apparatus.

2. Related Art

There has been known a pyroelectric body which is a substance showing a phenomenon (pyroelectric effect) in which polarization (surface electric charge) changes according to a change in temperature.

Then, there has been known, as a light sensor, a thermal photodetector which absorbs light emitted from an object by a light absorbing layer, converts the light to heat, and measures a change in temperature by a thermal detection element.

There are various types of thermal photodetectors, however, in terms of having excellent sensitivity, a thermal photodetector provided with a pyroelectric element constituted by a material including a pyroelectric body has been widely used (see, for example, JP-A-2013-134081).

As the material constituting the pyroelectric element, lead zirconate titanate has been used, however, this material contains lead (Pb) as a constituent element, and therefore is not preferred from the viewpoint of environmental problems and the like.

Further, there has also been an attempt to use a pyroelectric body other than lead zirconate titanate, however, a high pyroelectric coefficient (sensitivity) could not be stably obtained in the past.

### SUMMARY

An advantage of some aspects of the invention is to provide a pyroelectric body capable of obtaining a high pyroelectric coefficient (sensitivity) stably over a wide temperature range, to provide a pyroelectric element constituted by a material including the pyroelectric body, to provide a production method for a pyroelectric element capable of efficiently producing the pyroelectric element, to provide a thermoelectric conversion element including the pyroelectric element, to provide a production method for a thermoelectric conversion element capable of efficiently producing the thermoelectric conversion element, to provide a thermal photodetector including the pyroelectric element, to provide a production method for a thermal photodetector capable of efficiently producing the thermal photodetector, and to provide an electronic apparatus including the thermal photodetector.

Such an advantage is achieved by aspects of the invention described below.

A pyroelectric body according to an aspect of the invention includes an oxide containing iron, manganese, bismuth, and gadolinium, wherein the oxide has a perovskite-type crystal structure, and in the oxide, the ratio of the number of atoms of gadolinium to the total number of atoms of A-site elements is 8.0 at % or more and 18 at % or less.

According to this configuration, a pyroelectric body capable of obtaining a high pyroelectric coefficient (sensitivity) stably over a wide temperature range can be provided.

In the pyroelectric body according to the aspect of the invention, it is preferred that in the oxide, the ratio of the number of atoms of manganese to the total number of atoms of B-site elements is 1.0 at % or more and 2.0 at % or less.

According to this configuration, an excellent insulating property and an excellent residual polarization amount can be achieved at a higher level.

In the pyroelectric body according to the aspect of the invention, it is preferred that in the oxide, the ratio of the number of atoms of titanium to the total number of atoms of B-site elements is 0 at % or more and 4.0 at % or less.

According to this configuration, an excellent insulating property and an excellent residual polarization amount can be achieved at a higher level.

In the pyroelectric body according to the aspect of the invention, it is preferred that the pyroelectric body is used at an environmental temperature in the range of −40° C. or higher and 40° C. or lower.

According to this configuration, the pyroelectric coefficient (sensitivity) of the pyroelectric body can be made particularly high, and also the stability of the pyroelectric coefficient (sensitivity) can be made particularly high. Further, such a temperature range is a highly practical temperature range, and when the pyroelectric body according to the aspect of the invention is configured to be used in such a temperature range, the application range of the pyroelectric body becomes sufficiently wide.

A pyroelectric element according to another aspect of the invention includes a first electrode, the pyroelectric body according to the aspect of the invention, and a second electrode.

According to this configuration, a pyroelectric element which includes the pyroelectric body capable of obtaining a high pyroelectric coefficient (sensitivity) stably over a wide temperature range and has high reliability can be provided.

A production method for a pyroelectric element according to still another aspect of the invention includes stacking a first electrode, the pyroelectric body according to the aspect of the invention, and a second electrode.

According to this configuration, a production method for a pyroelectric element capable of efficiently producing a pyroelectric element which includes the pyroelectric body capable of obtaining a high pyroelectric coefficient (sensitivity) stably over a wide temperature range and has high reliability can be provided.

A thermoelectric conversion element according to yet another aspect of the invention includes: the pyroelectric element according to the aspect of the invention; a light absorbing layer; and an insulating layer provided between the pyroelectric element and the light absorbing layer.

According to this configuration, a thermoelectric conversion element which includes the pyroelectric body capable of obtaining a high pyroelectric coefficient (sensitivity) stably over a wide temperature range and has high reliability can be provided.

A production method for a thermoelectric conversion element according to still yet another aspect of the invention includes: forming the pyroelectric element according to the aspect of the invention; and forming a light absorbing layer through an insulating layer so as to cover at least a part of the pyroelectric element.

According to this configuration, a production method for a thermoelectric conversion element capable of efficiently producing a thermoelectric conversion element which includes the pyroelectric body capable of obtaining a high pyroelectric coefficient (sensitivity) stably over a wide temperature range and has high reliability can be provided.

A thermal photodetector according to further another aspect of the invention includes the pyroelectric element according to the aspect of the invention.

According to this configuration, a thermal photodetector which includes the pyroelectric body capable of obtaining a high pyroelectric coefficient (sensitivity) stably over a wide temperature range and has high reliability can be provided.

A thermal photodetector according to still further another aspect of the invention includes a pyroelectric element produced by using the production method for a pyroelectric element according to the aspect of the invention.

According to this configuration, a thermal photodetector which includes the pyroelectric body capable of obtaining a high pyroelectric coefficient (sensitivity) stably over a wide temperature range and has high reliability can be provided.

A production method for a thermal photodetector according to yet further another aspect of the invention includes: preparing a base member having a substrate and a sacrifice layer; forming a support member on a surface of the base member on a side where the sacrifice layer is provided; forming the pyroelectric element according to the aspect of the invention on the support member; forming alight absorbing layer so as to cover an outer surface of the pyroelectric element through an insulating layer; patterning the support member; and etching the sacrifice layer.

According to this configuration, a production method for a thermal photodetector capable of efficiently producing a thermal photodetector which includes the pyroelectric body capable of obtaining a high pyroelectric coefficient (sensitivity) stably over a wide temperature range and has high reliability can be provided.

An electronic apparatus according to still yet further another aspect of the invention includes the thermal photodetector according to the aspect of the invention.

According to this configuration, an electronic apparatus which includes the pyroelectric body capable of obtaining a high pyroelectric coefficient (sensitivity) stably over a wide temperature range and has high reliability can be provided.

An electronic apparatus according to a further aspect of the invention includes a thermal photodetector produced by the production method for a thermal photodetector according to the aspect of the invention.

According to this configuration, an electronic apparatus which includes the pyroelectric body capable of obtaining a high pyroelectric coefficient (sensitivity) stably over a wide temperature range and has high reliability can be provided.

### BRIEF DESCRIPTION OF THE DRAWINGS

The invention will be described with reference to the accompanying drawings, wherein like numbers reference like elements.

FIG. 1 is a plan view of a thermal photodetector according to a first embodiment of the invention.

FIG. 2 is a cross-sectional view taken along the line A-A of FIG. 1.

FIGS. 3A and 3B are views sequentially showing main steps in a production method for the thermal photodetector according to the first embodiment of the invention.

FIGS. 4A and 4B are views sequentially showing main steps in the production method for the thermal photodetector according to the first embodiment of the invention.

FIGS. 5A and 5B are views sequentially showing main steps in the production method for the thermal photodetector according to the first embodiment of the invention.

FIGS. 6A and 6B are views sequentially showing main steps in the production method for the thermal photodetector according to the first embodiment of the invention.

FIG. 7 is a plan view of a thermal photodetector according to a second embodiment of the invention.

FIG. 8 is a plan view showing a thermal photodetection device according to a third embodiment of the invention.

FIG. 9 is a structural view of an electronic apparatus according to a preferred embodiment of the invention.

FIGS. 10A and 10B are structural views of a sensor device of the electronic apparatus according to the preferred embodiment of the invention.

FIG. 11 is a structural view of a terahertz camera as the electronic apparatus according to the preferred embodiment of the invention.

### DESCRIPTION OF EXEMPLARY EMBODIMENTS

Hereinafter, preferred embodiments of the invention will be described in detail with reference to the accompanying drawings.

### Pyroelectric Body

First, a pyroelectric body according to the invention will be described.

The pyroelectric body according to the invention includes an oxide containing iron (Fe), manganese (Mn), bismuth (Bi), and gadolinium (Gd).

The oxide has a perovskite-type crystal structure, and the ratio of the number of atoms of gadolinium (Gd) to the total number of atoms of A-site elements is 8.0 at % or more and 18 at % or less.

According to such a configuration, the pyroelectric body shows double hysteresis properties and thus has a high pyroelectric coefficient (sensitivity) stably over a wide temperature range.

On the other hand, if the conditions described above are not satisfied, a satisfactory result cannot be obtained.

For example, if the ratio of the number of atoms of gadolinium (Gd) to the total number of atoms of A-site elements of the perovskite-type crystal structure is less than the above lower limit, the oxide shows, for example, ferroelectric hysteresis properties, and therefore, a sufficient pyroelectric coefficient (sensitivity) cannot be obtained.

Further, if the ratio of the number of atoms of gadolinium (Gd) to the total number of atoms of A-site elements of the perovskite-type crystal structure exceeds the above upper limit, the oxide becomes a paraelectric body or shows properties close to the properties of a paraelectric body, and therefore, electric field-induced phase transition is hard to occur, and thus, the pyroelectric coefficient (sensitivity) becomes low.

It is also considered that a high pyroelectric coefficient is obtained by using an A-site element other than gadolinium (Gd) such as lanthanum (La), however, in such a case, the stability of the pyroelectric coefficient (for example, the stability in the case where a change in temperature occurs) significantly decreases. Further, in the case where an A-site element other than gadolinium (Gd) such as lanthanum (La) is used, the pyroelectric coefficient at around room temperature generally significantly decreases, and therefore, the utility value is low.

In this specification, with respect to a given numerical value, the expressions “(numerical value) or more (higher)” and “(numerical value) or less (lower)” are used for a range including the numerical value, and the expressions “less than (numerical value)” and “exceeding (numerical value)” are used for a range excluding the numerical value.

As described above, in the invention, the ratio of the number of atoms of gadolinium (Gd) to the total number of atoms of A-site elements of the perovskite-type crystal structure may be 8.0 at % or more and 18 at % or less, but is preferably 10 at % or more and 18 at % or less, more preferably 13 at % or more and 17 at % or less.

According to this, the effect as described above is more remarkably exhibited.

In the pyroelectric body according to the invention, the oxide having a perovskite-type crystal structure contains bismuth (Bi) and gadolinium (Gd) as A-site elements, but may contain an A-site element (another A-site element) other than these elements. Examples of such an element include various lanthanoid elements such as La, Ce, Pr, and Nd, and Ba and Ca. In this manner, even when another A-site element is contained, the content of the another A-site element to the total number of atoms of A-site elements is preferably 7.0 at % or less, more preferably 5.0 at % or less. According to this, the effect as described above is more remarkably exhibited.

In the pyroelectric body according to the invention, the oxide having a perovskite-type crystal structure contains iron (Fe) and manganese (Mn) as B-site elements, but may contain a B-site element (another B-site element) other than these elements. Examples of such an element include titanium (Ti) and cobalt (Co). In this manner, even when another B-site element is contained, the content of the another B-site element to the total number of atoms of B-site elements is preferably 5.0 at % or less, more preferably 4.0 at % or less. According to this, the effect as described above is more remarkably exhibited.

In the oxide constituting the pyroelectric body, the ratio of the number of atoms of manganese (Mn) to the total number of atoms of B-site elements is not particularly limited, but is preferably 1.0 at % or more and 2.0 at % or less, more preferably 1.2 at % or more and 1.8 at % or less.

According to this, an excellent insulating property and an excellent residual polarization amount can be achieved at a higher level.

In the oxide constituting the pyroelectric body, the ratio of the number of atoms of titanium (Ti) to the total number of atoms of B-site elements is not particularly limited, but is preferably 0 at % or more and 4.0 at % or less, more preferably 0 at % or more and 3.0 at % or less.

According to this, an excellent insulating property and an excellent residual polarization amount can be achieved at a higher level.

Further, the pyroelectric body according to the invention may contain one or more components (other components) other than the above-mentioned oxide (the oxide containing iron, manganese, bismuth, and gadolinium).

In such a case, the content of the other components (components other than the above-mentioned oxide) contained in the pyroelectric body is preferably 2.0 mass % or less, more preferably 1.0 mass % or less.

According to this, the effect of the invention as described above can be more effectively exhibited.

Examples of the other components (components other than the above-mentioned oxide) to be contained in the pyroelectric body include oxides other than the above-mentioned oxide (the oxide containing iron, manganese, bismuth, and gadolinium), lanthanoids (neodymium, gadolinium, cerium, and the like), barium, calcium, and cobalt.

As described above, in the pyroelectric body according to the invention, a high pyroelectric coefficient (sensitivity) is obtained stably over a wide temperature range.

Therefore, the pyroelectric body according to the invention may be used in any temperature range, but is preferably used at an environmental temperature in the range of −40° C. or higher and 40° C. or lower, more preferably used at an environmental temperature in the range of −30° C. or higher and 40° C. or lower.

In the pyroelectric body according to the invention, in such a temperature range, the pyroelectric coefficient (sensitivity) is particularly high, and also the stability of the pyroelectric coefficient (sensitivity) is particularly high, and therefore, for example, a variation in output caused by a variation in the temperature of the pyroelectric element constituted by a material including the pyroelectric body can be made particularly small, and thus, the reliability of a thermal photodetector or the like including the pyroelectric element can be made particularly excellent.

Further, such a temperature range is generally a highly practical temperature range including a temperature in a non-air-conditioned room, a temperature in a freezer for business use, and the like, and when the pyroelectric body according to the invention is configured to be used in such a temperature range, the application range of the pyroelectric body becomes sufficiently wide.

### Production Method for Pyroelectric Body

Next, a production method for the pyroelectric body according to the invention as described above will be described.

The pyroelectric body according to the invention as described above may be produced by any method, but is preferably produced by heating a solution in which a fatty acid metal salt is dissolved in an organic solvent.

According to this, the pyroelectric body having a high pyroelectric coefficient (sensitivity) stably over a wide temperature range can be efficiently produced.

As the fatty acid metal salt, at least some metal elements among the metal elements constituting the oxide may be used, however, it is preferred to use fatty acid metal salts of each of the essential metal elements constituting the oxide, that is, each of iron, manganese, bismuth, and gadolinium.

Examples of the fatty acid constituting the fatty acid metal salt include formic acid, acetic acid, propionic acid, butyric acid, valeric acid, caproic acid, enanthic acid, and caprylic acid, but particularly, acetic acid is preferred.

According to this, the solubility of the fatty acid metal salt in an organic solvent, the ease of a chemical reaction to form the above-mentioned oxide, and the like can be made favorable.

In the case where the fatty acid metal salts are used for a plurality of types of metal elements, with respect to the respective metal elements, the same fatty acid may be used, or different fatty acids may be used.

Further, with respect to the fatty acid metal salts for arbitrary metal elements, a single fatty acid may be used, or a plurality of types of fatty acids may be used in combination.

Examples of the organic solvent to dissolve the fatty acid metal salt include fatty acids such as formic acid, acetic acid, propionic acid, butyric acid, valeric acid, caproic acid, enanthic acid, and caprylic acid; (poly)alkylene glycol monoalkyl ethers such as ethylene glycol monomethyl ether, ethylene glycol monoethyl ether, propylene glycol monomethyl ether, and propylene glycol monoethyl ether; fatty acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetyl acetone; and alcohols such as ethanol, propanol, butanol, ethylene glycol, and glycerin, and one type or a combination of two or more types of organic solvents selected from these can be used, however, it is preferred to use a fatty acid.

The fatty acid generally has particularly high solubility of the fatty acid metal salt, and also has moderate viscosity, and therefore, not only facilitates the handling of the solvent or the solution, but also can more effectively prevent the occurrence of an undesired variation in the composition of the pyroelectric body to be produced at each position. Further, the fatty acid generally has moderately high boiling point, and therefore, the chemical reaction to form the above-mentioned oxide by heating can be made to favorably proceed.

Among the fatty acids, propionic acid is preferred as the fatty acid serving as the organic solvent to dissolve the fatty acid metal salt.

According to this, the solubility of the fatty acid metal salt in the organic solvent, the ease of the chemical reaction to form the above-mentioned oxide, and the like can be made favorable. Further, the chemical reaction can be carried out at a relatively high temperature using a simple apparatus or device, and also the removal of the solvent after the chemical reaction is easy. As a result, the productivity of the pyroelectric body can be made particularly excellent, and also the solvent can be more reliably prevented from undesirably remaining in the obtained pyroelectric body.

The heating temperature (reaction temperature) of the solution in which the fatty acid metal salt is dissolved in the organic solvent is not particularly limited, but is preferably 90° C. or higher and 250° C. or lower, more preferably 100° C. or higher and 200° C. or lower.

According to this, the pyroelectric body having a desired composition can be produced with higher productivity while preventing an undesired variation in the composition and the like of the obtained pyroelectric body.

### Pyroelectric Element, Thermoelectric Conversion Element, Thermal Photodetector (Thermal Photodetection Device)

Next, a pyroelectric element, a thermoelectric conversion element, and a thermal photodetector according to the invention will be described.

### First Embodiment

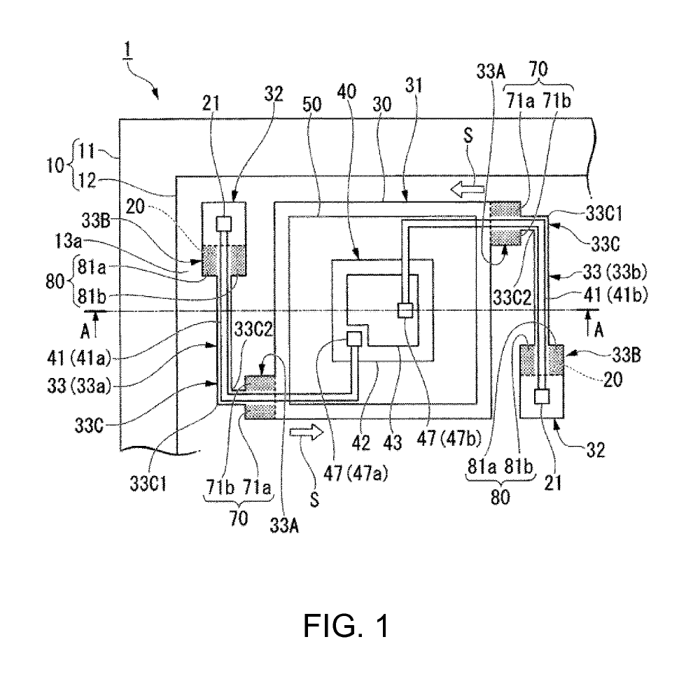

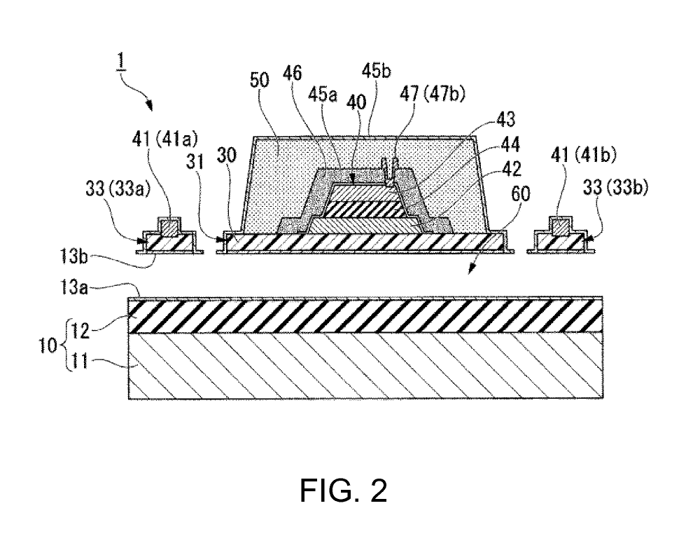

FIG. 1 is a plan view of a thermal photodetector according to a first embodiment of the invention, and FIG. 2 is a cross-sectional view taken along the line A-A of FIG. 1.

A thermal photodetector 1 shown in FIGS. 1 and 2 is a pyroelectric infrared detector (a type of photosensor). This thermal photodetector 1 converts heat generated by light absorption by a light absorbing layer 50 to an electrical signal in a thermal detection element (pyroelectric element) 40. The thermal photodetector 1 is configured to output a detection signal (electrical signal) corresponding to the intensity of received light by the light absorbing layer 50 and the thermal detection element 40.

The thermal photodetector 1 has a base member 10 and a post (pillar member) 20 as shown in FIG. 1, and also has a support member 30, the thermal detection element 40, and the light absorbing layer 50 as shown in FIG. 2.

As shown in FIG. 2, the base member 10 includes a substrate 11 and a spacer layer 12 formed on the substrate 11. The substrate 11 is formed from, for example, a silicon substrate. This substrate 11 is provided with an electrical circuit (not shown) and is configured to be electrically connected to the thermal detection element 40 through the post 20 (see FIG. 1).

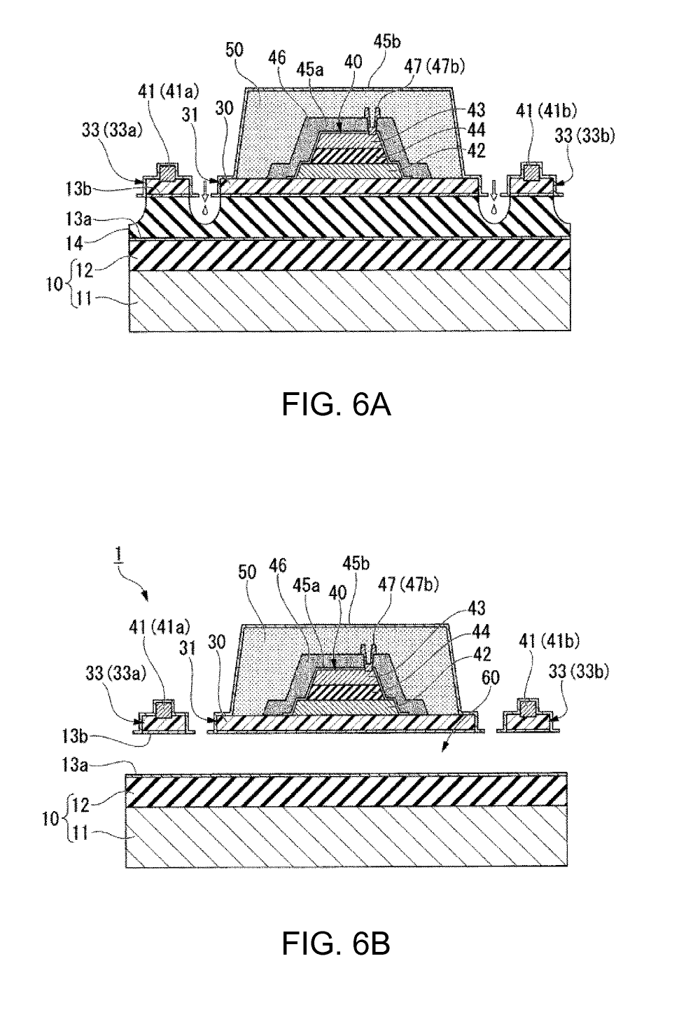

The spacer layer 12 is an insulating layer and is formed from, for example, SiO₂ or the like. On this spacer layer 12, an etching stopper film 13a is formed. The etching stopper film 13a prevents layers which are not to be etched from being removed in a step of removing a sacrifice layer 14 (see FIGS. 6A and 6B described later) for forming a cavity section 60. The etching stopper film 13a is formed from, for example, Si₃N₄, Al₂O₃, or the like. Also on the lower surface of the support member 30, an etching stopper film 13b having the same configuration as that of the etching stopper film 13a is formed.

The post 20 is provided vertically like a pillar from the base member 10. In this embodiment, as shown in FIG. 1, two posts 20 are provided and are configured to support the support member 30 at two points. In the post 20, a plug 21 to be electrically connected to the thermal detection element 40 is disposed. The plug 21 is connected to the electrical circuit (not shown) provided in the substrate 11. This post 20 is selectively formed by pattern etching the sacrifice layer 14 formed from SiO₂ or the like, and is formed simultaneously with the cavity section 60.

As shown in FIG. 1, the support member (membrane) 30 is supported by the two posts 20. The support member 30 has a main body section 31 which supports the thermal detection element 40 and the light absorbing layer 50, a connection section 32 which is connected to the post 20, and arm sections 33 (33a, 33b), each of which couples the main body section 31 and the connection section 32 together. The arm section 33 is configured such that two arms extend from an edge portion of the main body section 31 and are narrowly and lengthily formed so as to thermally separate the thermal detection element 40.

On the arm sections 33 (33a, 33b), wiring layers 41 (41a, 41b) are formed, respectively. The wiring layer 41a is connected to a first electrode 42 of the thermal detection element 40, and is provided extending along the arm section 33a and is connected to the electrical circuit in the substrate 11 through the post 20. Further, the wiring layer 41b is connected to a second electrode 43 of the thermal detection element 40, and is provided extending along the arm section 33b and is connected to the electrical circuit in the substrate 11 through the post 20. The wiring layers 41 (41a, 41b) are also narrowly and lengthily formed so as to thermally separate the thermal detection element 40.

The support member 30 can be formed by, for example, patterning a stacked film including the following three layers: a silicon oxide film (SiO)/a silicon nitride film (SiN)/a silicon oxide film (SiO). By configuring the support member 30 to have a stacked structure, for example, the high tensile residual stress in the nitride film serving as the intermediate layer is made to act to cancel out the compression residual stress in the two oxide film layers on the upper side and the lower side, so that the residual stress which causes warpage of the support member 30 can be decreased. This support member 30 stably supports the thermal detection element 40 and the light absorbing layer 50, and therefore, the total thickness of the support member 30 has a thickness satisfying a necessary mechanical strength. Incidentally, the support member 30 may not necessarily have a stacking structure, and may be formed from a single layer of a SiO₂ layer (first insulating layer).

As shown in FIG. 2, the thermal detection element 40 is supported by the support member 30 such that the cavity section 60 is interposed between the support member 30 and the base member 10. The thermal detection element 40 includes the first electrode (lower electrode) 42, the second electrode (upper electrode) 43, and a pyroelectric body (pyroelectric layer) 44 provided between the first electrode 42 and the second electrode 43. Both of the first electrode 42 and the second electrode 43 can be formed by, for example, stacking three metal film layers. For example, a three-layer structure of iridium (Ir), iridium oxide (IrOx), and platinum (Pt) formed by, for example, sputtering in the order from a position farther from the pyroelectric body 44 can be adopted.

The pyroelectric body 44 is constituted by the pyroelectric body according to the invention described above. When heat is transmitted to this pyroelectric body 44, due to the pyroelectric effect, the electric polarization amount in the pyroelectric body 44 changes. By detecting an electric current accompanying this change in the electric polarization amount, the intensity of incident light can be detected.

The pyroelectric body according to the invention has a high pyroelectric coefficient (sensitivity) stably over a wide temperature range, and therefore, the reliability of the thermal detection element 40 and the thermal photodetector 1 is high.

The thermal detection element (pyroelectric element) 40 according to this embodiment is configured such that the thermal resistance of the first electrode 42 which is in contact with the support member 30 is made larger than that of the second electrode 43 by the thickness or the constituent material. According to this configuration, heat is easily transmitted to the pyroelectric body 44 through the second electrode 43, and moreover, heat in the pyroelectric body 44 hardly escapes to the support member 30 through the first electrode 42, and thus, the sensitivity of the thermal detection element 40 is improved.

The thermal detection element 40 is covered with a protective film 45a. Further, the thermal detection element 40 is covered with an insulating layer 46 on the outer side of the protective film 45a. In general, when a starting material gas (TEOS) of the insulating layer 46 is subjected to a chemical reaction, a reducing gas such as hydrogen gas or water vapor is generated. The protective film 45a protects the thermal detection element 40 from the reducing gas generated during the formation of this insulating layer 46. This protective film 45a is formed from, for example, Al₂O₃ or the like. Incidentally, a part of the support member 30, the wiring layer 41, and the light absorbing layer 50 are also covered with a protective film 45b having the same configuration as that of the protective film 45a.

On the insulating layer 46, the wiring layers 41 (41a, 41b) are wired. In the insulating layer 46, contact holes 47 (47a, 47b) are formed. As shown in FIG. 2, the contact hole is also formed in the protective film 45a passing therethrough in the same manner. The wiring layer 41a is electrically conducted with the first electrode 42 through the contact hole 47a. Further, the wiring layer 41b is electrically conducted with the second electrode 43 through the contact hole 47b.

The light absorbing layer 50 is formed on the thermal detection element 40 covered with the insulating layer 46. The light absorbing layer 50 absorbs incident light and generates heat, and is formed from, for example, SiO₂ or the like. When the second electrode 43 is formed from a metal such as Pt, the upper surface of the second electrode 43 can be used as a reflection surface. In this case, by setting a distance L from the upper surface of the light absorbing layer 50 to the upper surface of the second electrode 43 to λ/4 (λ is the wavelength of incident light), an optical resonator (λ¼ optical resonator) in which light having a wavelength of λ undergoes multiple reflection can be formed. According to this, the light absorbing layer 50 can efficiently absorb light having a wavelength of λ.

In the thermal photodetector 1 having the above-mentioned configuration, the thermal detection element (pyroelectric element) 40 has the pyroelectric body 44 between the first electrode 42 and the second electrode 43, and is supported by the support member 30 such that the cavity section 60 is interposed between the support member 30 and the base member 10. Then, when light is incident on the light absorbing layer 50, the light resonates or the like so that the light absorbing layer 50 generates heat and the heat is transmitted to the pyroelectric body 44. In the pyroelectric body 44, due to the pyroelectric effect, the electric polarization amount changes, and accompanying this change in the electric polarization amount, an electric current flows in the electrical circuit of the substrate 11 through the wiring layers 41 (41a, 41b). By detecting the electric current, the intensity of the incident light can be detected.

Then, a thermoelectric conversion element is constituted by the thermal detection element (pyroelectric element) 40, the insulating layer 46, and the light absorbing layer 50.

In the thermal photodetector 1, the support member 30 has residual stress as described above. When warpage of the main body section 31 occurs by this residual stress, as shown in FIG. 1, rotation stress in a planar direction is applied such that the arm section 33 is rolled and pulled. The arm section 33 should be formed long and narrow due to its properties, and therefore, depending on the magnitude of this rotation stress S, a crack may occur in the arm section 33 or disconnection of the wiring layer 41 of the thermal detection element 40 may be caused in some cases.

Due to this, as shown in FIG. 1, the thermal photodetector 1 has a first wide section 70 and a second wide section 80, each of which is formed by partially widening the arm section 33 of the support member 30.

The first wide section (wide section) 70 is formed by partially widening the arm section 33 in a first coupling section (coupling section) 33A where the arm section 33 is coupled with the main body section 31. The first wide section 70 has expansion sections 71a and 71b, each of which is formed by partially expanding the arm section 33. The expansion sections 71a and 71b are formed integrally across the main body section 31 and the arm section 33, and are formed from the same material and have the same thickness as the support member 30. The expansion sections 71a and 71b of this embodiment are each formed in the shape of a rectangle in plan view. By these expansion sections 71a and 71b, the width of the first coupling section 33A is made larger than the width of an intermediate portion of the arm section 33.

The arm section 33 has a bending section 33C which bends along the main body section 31. That is, the arm section 33 extends from the main body section 31 formed in the shape of a rectangle in plan view in a direction parallel to a given side of the main body section 31, and thereafter bends at a right angle, and then extends in a direction parallel to another side adjacent to the given side of the main body section 31 and is connected to the connection section 32. In this manner, the arm sections 33a and 33b each formed in the shape of the letter L in plan view are formed in a point symmetry with respect to the center of the main body section 31.

The expansion section 71a of the first wide section 70 is formed by partially widening the arm section 33 on one side in the width direction corresponding to an outer side 33C1 of the bending section 33C in the first coupling section 33A. Further, the expansion section 71b of the first wide section 70 is formed by partially widening the arm section 33 on the other side in the width direction corresponding to an inner side 33C2 of the bending section 33C in the first coupling section 33A. In this manner, in this embodiment, the first wide section 70 is configured to be formed by partially widening the arm section 33 on both sides in the width direction corresponding to the inner side 33C2 and the outer side 33C1 of the bending section 33C in the first coupling section 33A.

The second wide section 80 is formed by partially widening the arm section 33 in a second coupling section 33B where the arm section 33 is coupled with the connection section 32. The second wide section 80 has expansion sections 81a and 81b, each of which is formed by partially expanding the arm section 33. The expansion sections 81a and 81b are formed integrally across the connection section 32 and the arm section 33, and are formed from the same material and have the same thickness as the support member 30. The expansion sections 81a and 81b of this embodiment are each formed in the shape of a rectangle in plan view. By these expansion sections 81a and 81b, the width of the second coupling section 33B is made larger than the width of an intermediate portion of the arm section 33.

The expansion section 81a of the second wide section 80 is formed by partially widening the arm section 33 on one side in the width direction corresponding to an outer side 33C1 of the bending section 33C in the second coupling section 33B. Further, the expansion section 81b of the second wide section 80 is formed by partially widening the arm section 33 on the other side in the width direction corresponding to an inner side 33C2 of the bending section 33C in the second coupling section 33B. In this manner, in this embodiment, the second wide section 80 is configured to be formed by partially widening the arm section 33 on both sides in the width direction corresponding to the inner side 33C2 and the outer side 33C1 of the bending section 33C in the second coupling section 33B.

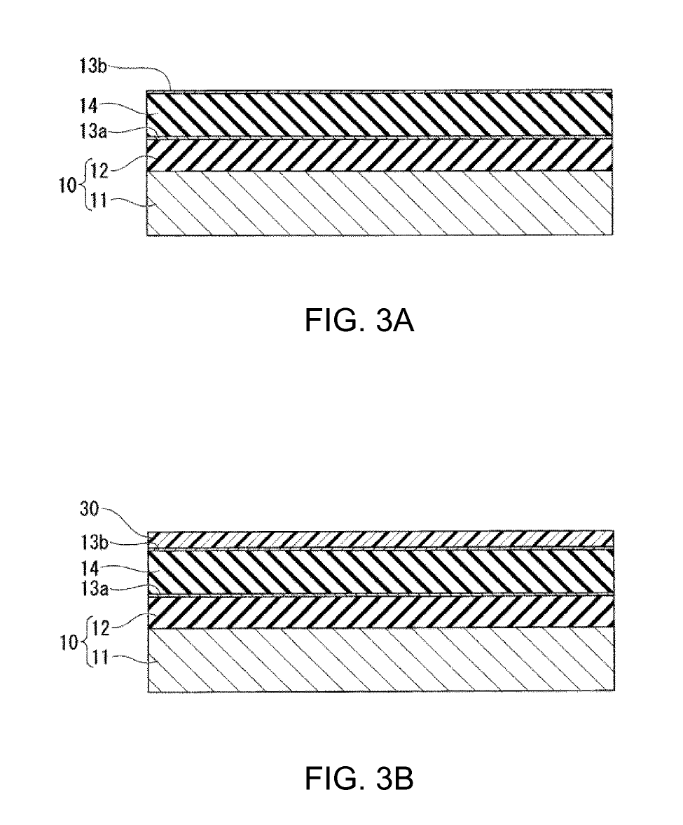

Next, a production method for the thermal photodetector 1 having the above-mentioned configuration will be described with reference to FIGS. 3A to 6B.

FIGS. 3A to 6B are views sequentially showing main steps in a production method for the thermal photodetector according to the first embodiment of the invention.

First, as shown in FIG. 3A, a spacer layer 12 is formed on a substrate 11. Further, on the spacer layer 12, an etching stopper film (a first etching stopper film) 13a is formed, and further, a sacrifice layer 14, an etching stopper film (a second etching stopper film) 13b are formed (a base member forming step). As a method for forming the etching stopper films 13a and 13b, for example, anatomic layer chemical vapor deposition (ALCVD) method capable of adjusting a film thickness to an atomic size level can be used.

Subsequently, as shown in FIG. 3B, on the etching stopper film 13b, a three-layer stacked film which becomes a support member 30 is formed (a membrane forming step).

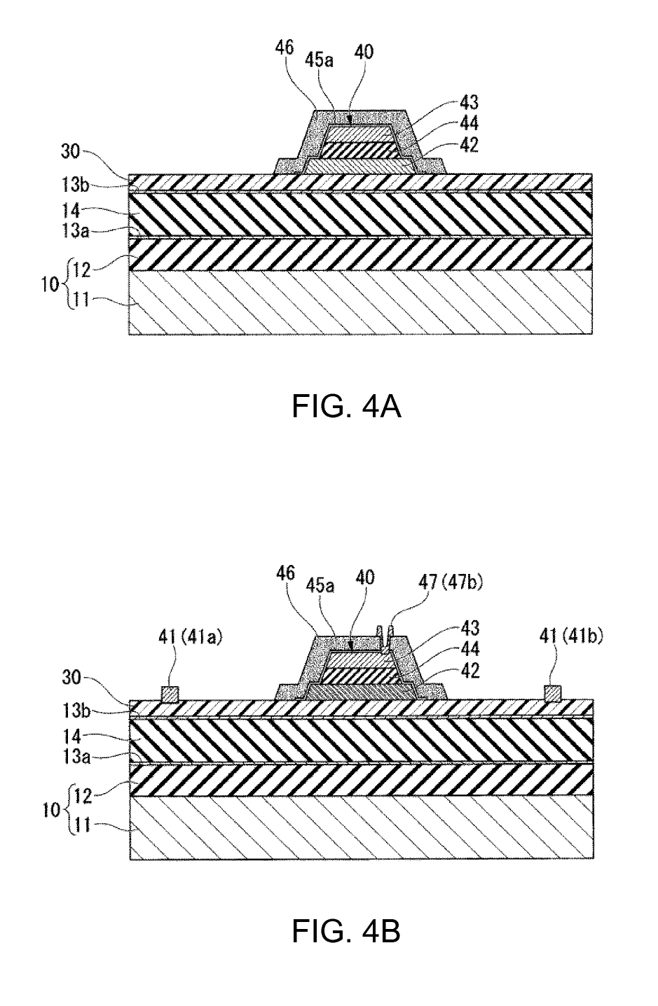

Subsequently, as shown in FIG. 4A, on the support member 30, a first electrode 42, a pyroelectric body 44, a second electrode 43 are stacked and formed, whereby a thermal detection element (pyroelectric element) 40 is formed, and also a protective film (first protective film) 45a and an insulating layer 46 are formed (a pyroelectric element forming step). As a method for forming the protective film 45a, for example, an atomic layer chemical vapor deposition (ALCVD) method can be used. Further, as a method for forming the insulating layer 46, for example, a common CVD method can be used.

Subsequently, in the first electrode 42 and the second electrode 43 of the thermal detection element 40, contact holes 47 (47a, 47b) are formed, respectively, and further, wiring layers 41 (41a, 41b) are formed, respectively (a wiring layer forming step). The protective film 45a prevents a reducing gas from entering the thermal detection element 40 when the contact holes 47 are formed in the insulating layer 46.

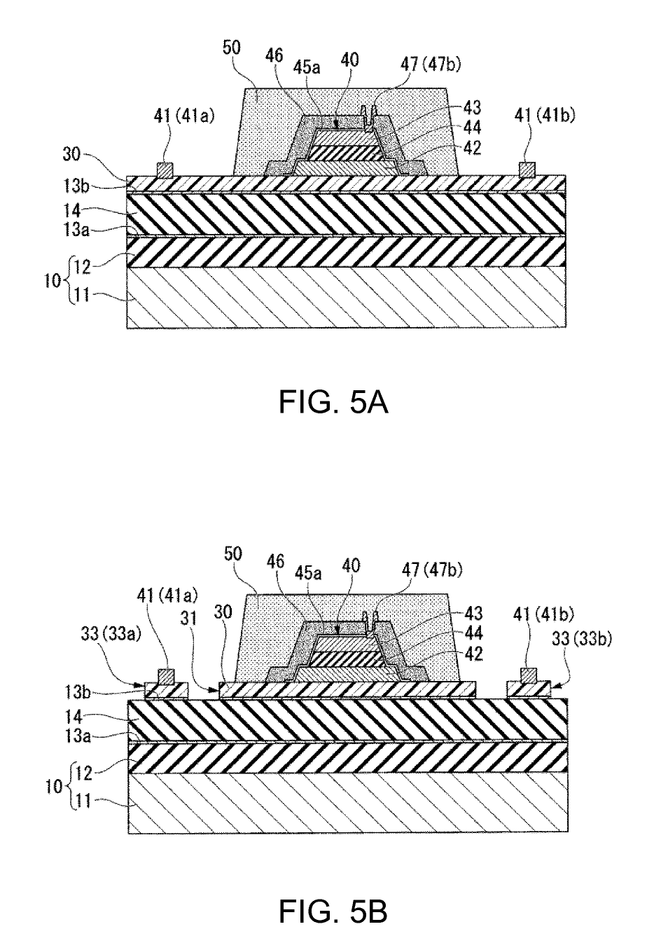

Subsequently, as shown in FIG. 5A, alight absorbing layer 50 is formed and patterned (a light absorbing layer forming step). As a method for forming the light absorbing layer 50, for example, a common CVD method can be used. Further, the surface of the light absorbing layer 50 may be flattened by, for example, CMP (chemical mechanical polishing).

Subsequently, the support member 30 is patterned, and a main body section 31, a connection section 32, and an arm section 33 are formed (a membrane processing step). In this step, also expansion sections 71a and 71b of a first wide section 70 and expansion sections 81a and 81b of a second wide section 80 are formed simultaneously by patterning.

Subsequently, as shown in FIG. 6A, a protective film (second protective film) 45b for use in the etching of the sacrifice layer 14 is formed, and the sacrifice layer 14 is wet etched (a sacrifice layer etching step). When the sacrifice layer 14 is wet etched, the etching stopper film 13a protects the spacer layer 12, and the etching stopper film 13b protects the support member 30.

Finally, as shown in FIG. 6B, the sacrifice layer 14 is removed by wet etching, whereby a cavity section 60 is formed (a cavity processing step). Further, by selectively removing the sacrifice layer 14, also a post 20 is formed simultaneously with the cavity section 60. By the cavity section 60, the support member 30 is separated from the base member 10, and heat dissipation through the support member 30 is prevented. In this manner, a thermal photodetector 1 is produced.

The thermal photodetector 1 and the pyroelectric element 40 as described above have a high pyroelectric coefficient (sensitivity) stably over a wide temperature range, and therefore have high reliability.

In particular, the thermal photodetector 1 having a configuration as shown in FIG. 1 has the first wide section 70 formed by partially widening the arm section 33 in the first coupling section 33A where the arm section 33 is coupled with the main body section 31. According to this configuration, the first coupling section 33A of the arm section 33 coupled with the main body section 31 in the support member 30 is formed partially wide, and therefore, the rigidity of the arm section 33 in the first coupling section 33A can be increased, and therefore, a breakage due to residual stress in the support member 30 generated in the above-mentioned production process can be suppressed. Further, when the arm section 33 is formed wide, the thermal resistance is increased, however, the thermal resistance is determined by the minimum width of the arm section 33, and therefore, by forming the wide portion of the arm section 33 partially, the heat conduction to the base member 10 through the arm section 33 can be suppressed, and thus, a decrease in the detection characteristics of the thermal detection element 40 can be prevented.

Further, the first wide section 70 is configured to be formed by partially widening the arm section 33 on both sides in the width direction corresponding to an inner side 33C2 and an outer side 33C1 of a bending section 33C in the first coupling section 33A. In the case where the arm section 33 has the bending section 33C which bends along the main body section 31 as this embodiment, when rotation stress S in a planar direction is applied such that the arm section 33 is rolled and pulled by the main body section 31, tensile stress is applied to the outer side 33C1 of the bending section 33C, and also compression stress is applied to the inner side 33C2 of the bending section 33C. Due to this, in the first coupling section 33A, by forming a portion of the arm section 33 on both sides corresponding to the inner side 33C2 and the outer side 33C1 of the bending section 33C wide, the rigidity of the arm section 33 in the first coupling section 33A can be further increased.

Further, the thermal photodetector 1 has the second wide section 80 formed by partially widening the arm section 33 in the second coupling section 33B where the arm section 33 is coupled with the connection section 32. According to this configuration, in the same manner as the above-mentioned first coupling section 33A, the rigidity of the arm section 33 in the second coupling section 33B can be increased, and thus, a breakage due to residual stress can be suppressed.

Further, the second wide section 80 is configured to be formed by partially widening the arm section 33 on both sides in the width direction corresponding to the inner side 33C2 and the outer side 33C1 of the bending section 33C in the second coupling section 33B so as to be able to cope with tensile stress and compression stress due to the existence of the bending section 33C, and thus, the rigidity of the arm section 33 in the second coupling section 33B can be further increased.

Therefore, according to this embodiment described above, the thermal photodetector 1 includes the base member 10, the post 20 provided vertically on the base member 10, the support member 30 supported by the post 20, the thermal detection element 40 supported by the support member 30 such that the cavity section 60 is interposed between the support member 30 and the base member 10, and the light absorbing layer 50 formed on the thermal detection element 40, and by adopting a configuration in which the support member 30 has the main body section 31 which supports the thermal detection element 40 and the light absorbing layer 50, the connection section 32 which is connected to the post 20, and the arm section 33 which couples the main body section 31 and the connection section 32 together, and the arm section 33 has the first wide section 70 formed by partially widening the arm section 33 in the first coupling section 33A where the arm section 33 is coupled with the main body section 31, the occurrence of a crack in the arm section 33 or the disconnection of the wiring layer 41 of the thermal detection element 40 can be effectively suppressed, and therefore, the thermal photodetector 1 capable of improving the yield is obtained.

Further, according to the above-mentioned method, a thermal photodetector and a pyroelectric element (pyroelectric capacitor) having high reliability can be efficiently produced.

### Second Embodiment

Next, a second embodiment of the thermal photodetector according to the invention will be described.

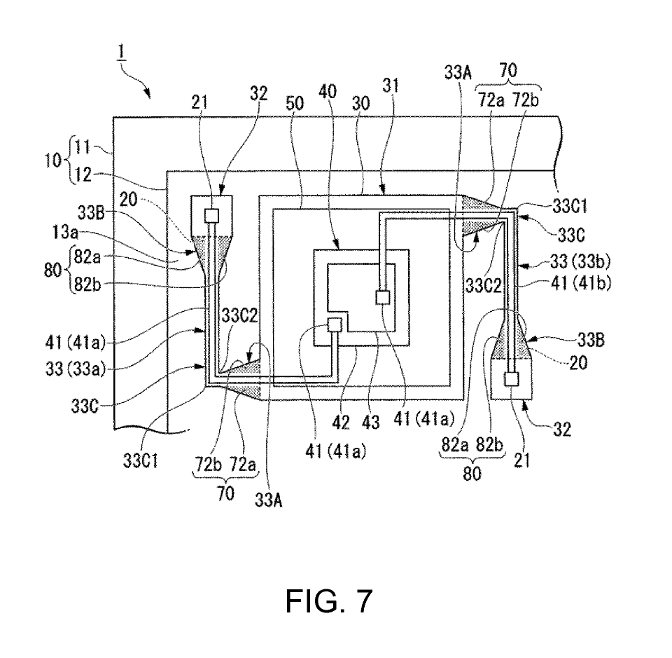

FIG. 7 is a plan view of the thermal photodetector according to the second embodiment of the invention. In the following description, the different point from the above-mentioned embodiment will be mainly described, and a description of the same matter will be omitted.

As shown in FIG. 7, the second embodiment is different from the above-mentioned embodiment in the configuration of the first wide section 70 and the second wide section 80.

The first wide section 70 of the second embodiment is configured such that the width of the arm section 33 gradually increases toward the main body section 31 in the first coupling section 33A. This first wide section 70 has expansion sections 72a and 72b formed by partially expanding the arm section 33. The expansion sections 72a and 72b are formed integrally across the main body section 31 and the arm section 33, and are formed from the same material and have the same thickness as the support member 30. The expansion sections 72a and 72b of this embodiment are each formed in the shape of a right triangle in plan view. Due to the expansion sections 72a and 72b, the width of the first coupling section 33A is made larger than the width of an intermediate portion of the arm section 33. This first wide section 70 can be formed by patterning in the above-mentioned membrane processing step.

Further, the second wide section 80 of the second embodiment is configured such that the width of the arm section 33 gradually increases toward the connection section 32 in the second coupling section 33B. This second wide section 80 has expansion sections 82a and 82b formed by partially expanding the arm section 33. The expansion sections 82a and 82b are formed integrally across the connection section 32 and the arm section 33, and are formed from the same material and have the same thickness as the support member 30. The expansion sections 82a and 82b of this embodiment are each formed in the shape of a right triangle in plan view. Due to the expansion sections 82a and 82b, the width of the second coupling section 33B is made larger than the width of an intermediate portion of the arm section 33. This second wide section 80 can be formed by patterning in the above-mentioned membrane processing step.

According to the second embodiment having the above-mentioned configuration, the width of the arm section 33 in the first coupling section 33A gradually increases toward the main body section 31, and therefore, the concentration of stress in the vicinity of the root of the arm section 33 can be alleviated. Therefore, the rigidity of the arm section 33 in the first coupling section 33A can be increased, and thus, a breakage due to residual stress in the support member 30 generated in the above-mentioned production process can be suppressed.

Further, according to the second embodiment having the above-mentioned configuration, the width of the arm section 33 in the second coupling section 33B gradually increases toward the connection section 32, and therefore, the concentration of stress in the vicinity of the tip of the arm section 33 can be alleviated. Therefore, the rigidity of the arm section 33 in the second coupling section 33B can be increased in the same manner as in the first coupling section 33A described above, and thus, a breakage due to residual stress can be suppressed.

Therefore, according to the second embodiment, the effect of the first embodiment described above is obtained, and also the concentration of stress in the vicinity of the root of the arm section 33 can be alleviated, and therefore, the occurrence of a crack in the arm section 33 or the disconnection of the wiring layer 41 of the thermal detection element 40 can be more effectively suppressed. Due to this, in the second embodiment, the thermal photodetector 1 capable of further improving the yield is obtained.

### Third Embodiment

Next, a third embodiment of the thermal photodetection device according to the invention will be described.

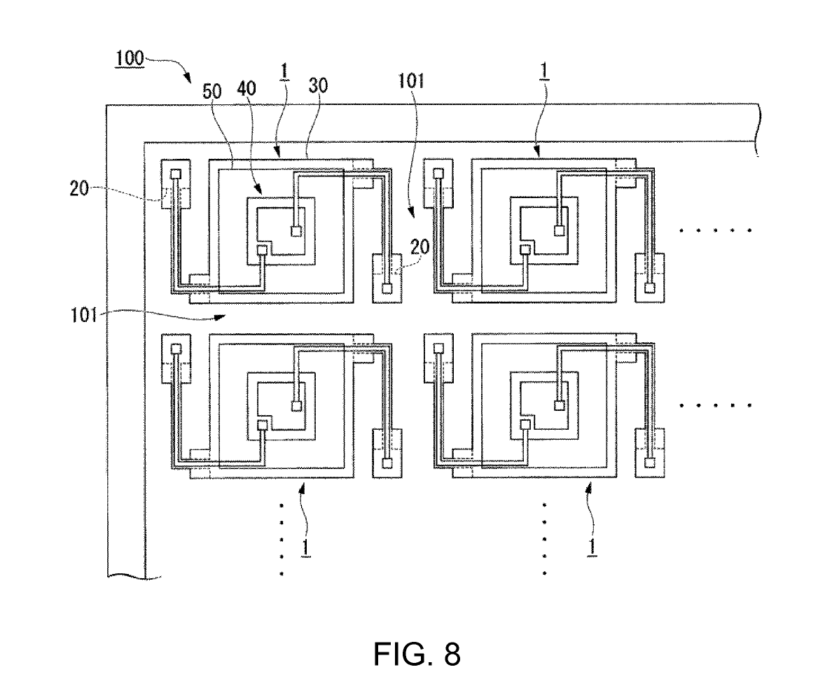

FIG. 8 is a plan view of the thermal photodetection device according to the third embodiment of the invention. In the following description, the different point from the above-mentioned embodiments will be mainly described, and a description of the same matter will be omitted.

As shown in FIG. 8, a thermal photodetection device 100 is configured such that a plurality of thermal photodetectors 1 are two-dimensionally arranged.

In the thermal photodetection device 100, the thermal photodetectors 1 are provided in the cell unit and arranged in biaxial directions, for example, in orthogonal biaxial directions. Incidentally, the thermal photodetection device 100 may be constituted by only one cell of the thermal photodetector 1. From the base member 10, a plurality of posts 20 are vertically provided, and for example, the thermal photodetectors 1, one cell of which is supported by two posts 20, are arranged in orthogonal biaxial directions. A region occupied by one cell of the thermal photodetector 1 has a size of, for example, 100×100 μm.

The thermal photodetector 1 includes a support member 30 coupled with the two posts 20, a thermal detection element 40, and a light absorbing layer 50. A region occupied by one cell of the thermal photodetector 1 has a size of, for example, 80×80 μm. The one cell of the thermal photodetector is provided in a non-contact manner except that it is connected to the two posts 20, and a cavity section 60 (see FIG. 2) is formed on the lower side of the thermal photodetector 1, and an opening section 101 communicating with the cavity section 60 is disposed around the thermal photodetector 1 in plan view. According to this, the one cell of the thermal photodetector 1 is thermally separated from the base member 10 and the other cells of the thermal photodetectors 1.

According to the third embodiment having the above-mentioned configuration, a thermal photodetection device (thermal photosensor array) 100 in which a plurality of the thermal photodetectors 1 are two-dimensionally arranged (for example, arranged in an array along each of two orthogonal axes (X axis and Y axis)) is realized.

### Electronic Apparatus

Next, the electronic apparatus according to the invention will be described.

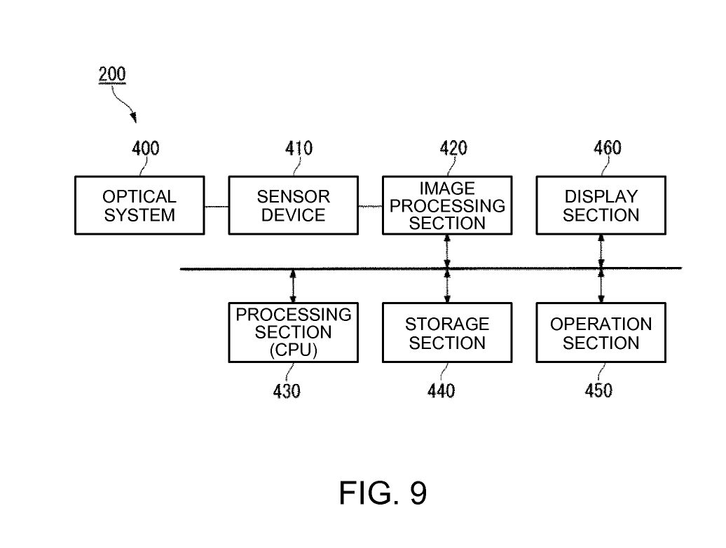

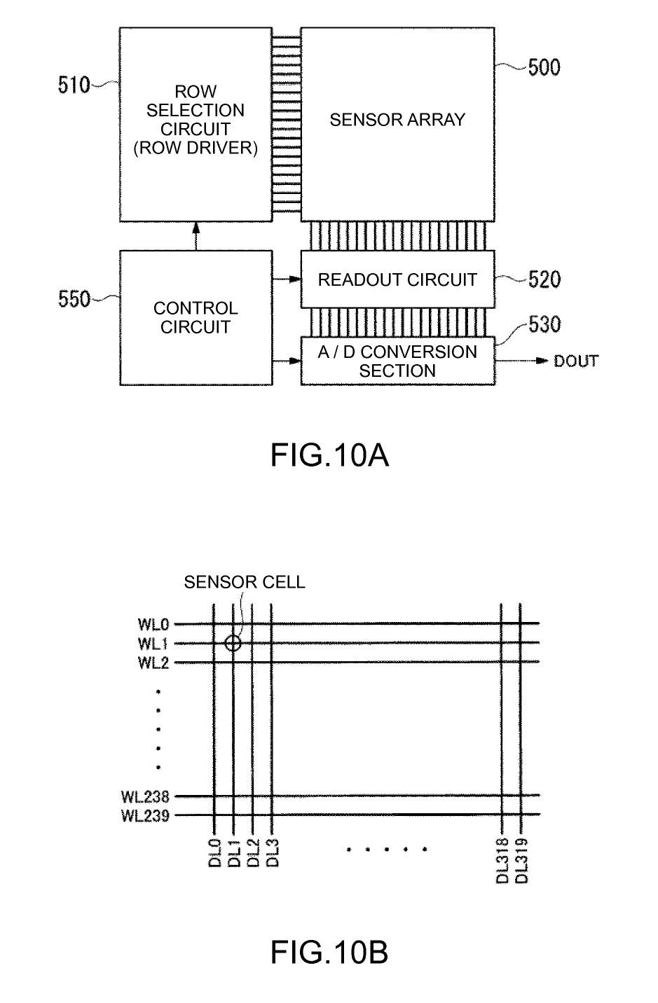

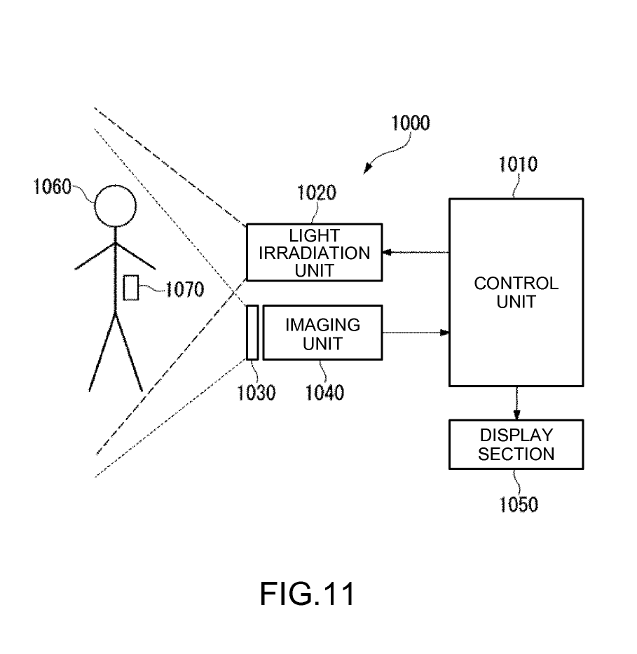

FIG. 9 is a structural view of an electronic apparatus according to a preferred embodiment of the invention. FIGS. 10A and 10B are structural views of a sensor device of the electronic apparatus according to the preferred embodiment of the invention. FIG. 11 is a structural view of a terahertz camera as the electronic apparatus according to the preferred embodiment of the invention.

As shown in FIG. 9, an electronic apparatus 200 has a sensor device 410 composed of the thermal photodetector 1 or the thermal photodetection device 100.

The electronic apparatus 200 includes an optical system 400, a sensor device 410, an image processing section 420, a processing section 430, a storage section 440, an operation section 450, and a display section 460. The configuration of the electronic apparatus 200 according to this embodiment is not limited to the configuration shown in FIG. 9, and various modifications such as omission of a part of the constituent elements (for example, the optical system, the operation section, the display section, or the like), or addition of another constituent element can be made.

The optical system 400 includes, for example, one or more lenses, a driving section for driving such a lens, and the like, and performs imaging of an object image for the sensor device 410 or the like, and if necessary also performs focus adjustment or the like.

The sensor device 410 is configured to two-dimensionally arrange the thermal photodetectors 1, and a plurality of row lines (word lines, scanning lines) and a plurality of column lines (data lines) are provided. The sensor device 410 can include a row selection circuit (row driver), a readout circuit for reading out data from the detector through the column line, an A/D conversion section, and the like in addition to the two-dimensionally arranged detectors. By sequentially reading out data from the respective two-dimensionally arranged detectors, a process for imaging an object image can be carried out.

The image processing section 420 performs a variety of image processing such as image correction processing based on digital image data (pixel data) from the sensor device 410.

The processing section 430 performs control of the entire electronic apparatus 200 and also performs control of the respective blocks in the electronic apparatus 200. This processing section 430 is realized by, for example, a CPU or the like. The storage section 440 stores a variety of information, and for example, functions as a work region for the processing section 430 or the image processing section 420. The operation section 450 serves as an interface for a user to operate the electronic apparatus 200, and is realized by, for example, various buttons, a GUI (Graphical User Interface) screen, or the like. The display section 460 displays, for example, an image obtained by the sensor device 410, a GUI screen, or the like, and is realized by any of various displays such as a liquid crystal display or an organic EL display.

In this manner, one cell of the thermal photodetector 1 can be used as a sensor, and other than this, the sensor device 410 can be constituted by two-dimensionally arranging a plurality of the thermal photodetectors 1 in biaxial directions, for example, in orthogonal biaxial directions, and by doing this, a heat distribution image derived from an electromagnetic wave can be provided. By using this sensor device 410, the electronic apparatus 200 using a specific substance detection device, a terahertz camera for discrimination of counterfeit paper money, detection of a chemical inside an envelope, nondestructive inspection of buildings, or the like can be constituted.

FIG. 10A shows a structural example of the sensor device 410 shown in FIG. 9. This sensor device includes a sensor array 500, a row selection circuit (row driver) 510, and a readout circuit 520. Further, the sensor device can also include an A/D conversion section 530 and a control circuit 550. By using this sensor device, a high-performance terahertz camera can be realized.

In the sensor array 500, for example, as shown in FIG. 8, a plurality of sensor cells are arranged (disposed) in a biaxial direction. Further, a plurality of row lines (word lines, scanning lines) and a plurality of column lines (data lines) are provided. Incidentally, the number of the row lines or the column lines may be one. For example, in the case where the number of the row lines is one, a plurality of sensor cells are arranged in a direction along the row line (horizontal direction) in FIG. 10B. On the other hand, in the case where the number of the column lines is one, a plurality of sensor cells are arranged in a direction along the column line (vertical direction) in FIG. 10B.

As shown in FIG. 10B, each of the sensor cells of the sensor array 500 is disposed (formed) at a position corresponding to a crossing position of each row line and each column line. For example, the sensor cell shown in FIG. 10B is disposed at a position corresponding to a crossing position of a row line WL1 and a column line DL1. The same shall apply to the other sensor cells.

The row selection circuit 510 is connected to one or a plurality of the row lines, and performs an operation of selecting the respective row lines. For example, if a QVGA (320×240 pixels) sensor array (focal plane array) 500 as shown in FIG. 10B is taken as an example, an operation of sequentially selecting (scanning) the row lines WL0, WL1, WL2, . . . , and WL239 is performed. That is, a signal (word selection signal) for selecting these row lines is output to the sensor array 500.

The readout circuit 520 is connected to one or a plurality of the column lines, and performs an operation of reading out the respective column lines. If the QVGA sensor array 500 is taken as an example, an operation of reading out a detection signal (detected electric current, detected electric charge) from the column lines DL0, DL1, DL2, DL3, . . . , and DL319 is performed.

The A/D conversion section 530 performs processing of A/D conversion of a detected voltage (measured voltage, ultimate voltage) obtained in the readout circuit 520 to digital data. Then, the resulting digital data DOUT after A/D conversion is output. More specifically, the A/D conversion section 530 is provided with A/D converters corresponding to each column line of the plurality of column lines. The respective A/D converters perform processing of A/D conversion of the detected voltage obtained by the readout circuit 520 at the corresponding column lines. Incidentally, one A/D converter may be provided corresponding to the plurality of column lines, and by using this one A/D converter, the A/D conversion of the detected voltage for the plurality of column lines may be performed in a time-division manner.

The control circuit (timing generation circuit) 550 generates various control signals and outputs the signals to the row selection circuit 510, the readout circuit 520, and the A/D conversion section 530. For example, the control circuit 550 generates and outputs a control signal for charging or discharging (reset), or generates and outputs a signal for controlling the timing of the respective circuits.

FIG. 11 shows a terahertz camera 1000 including the sensor device 410 according to this embodiment. An electromagnetic wave absorbing material of the light absorbing layer 50 of the sensor device 410 described above is set such that the absorption wavelength thereof becomes optimum at a terahertz frequency, and an example of configuring the terahertz camera 1000 in combination with a terahertz light irradiation unit is shown.

The terahertz camera 1000 is configured to include a control unit 1010, a light irradiation unit 1020, an optical filter 1030, an imaging unit 1040, and a display section 1050. The imaging unit 1040 is configured to include an optical system such as a lens (not shown), and a sensor device in which the absorption wavelength of the electromagnetic wave absorbing material of the light absorbing layer 50 of the thermal photodetector 1 described above is optimized in a terahertz range.

The control unit 1010 includes a system controller which controls the entire device, and the system controller controls a light source driving section and an image processing unit included in the control unit. The light irradiation unit 1020 includes a laser device which emits terahertz light (which refers to an electromagnetic wave having a wavelength in the range of 100 μm or more and 1,000 μm or less) and an optical system, and irradiates a person 1060 to be inspected with terahertz light. The terahertz light reflected from the person 1060 is received by the imaging unit 1040 through the optical filter 1030 which transmits only an optical spectrum of a specific substance 1070 to be detected. An image signal generated by the imaging unit 1040 is subjected to given imaging processing by the image processing unit of the control unit 1010, and the resulting image signal is output to the display section 1050. Then, since the intensity of the received light signal differs depending on the presence or absence of the specific substance 1070 in the clothes or the like of the person 1060, the presence of the specific substance 1070 can be determined.

The electronic apparatus according to the invention as described above has a thermal photodetector including the pyroelectric body according to the invention which stably exhibits a high pyroelectric coefficient (sensitivity) over a wide temperature range, and therefore has high reliability.

Hereinabove, preferred embodiments of the invention have been described, however, the invention is not limited thereto.

For example, the configuration of each part in the thermal photodetector or the electronic apparatus according to the invention can be replaced with an arbitrary configuration having a similar function, and also an arbitrary configuration may be added.

Further, the invention can be favorably applied to various thermal photodetectors. Further, examples of the electronic apparatus according to the invention include an infrared sensor device, a thermographic device, a car night vision camera, and a monitoring camera, but the electronic apparatus is not limited thereto.

### EXAMPLES

Hereinafter, the invention will be described in more detail with reference to specific examples, however, the invention is not limited only to these examples. Incidentally, in the following description, processing in which the temperature condition is not particularly specified was performed at room temperature (25° C.). Further, also with respect to various measurement conditions, the numerical values for which the temperature condition is not particularly specified are numerical values at room temperature (25° C.)

### [1] Production of Pyroelectric Body

### Example 1

Bismuth acetate, gadolinium acetate, iron acetate, manganese acetate, and titanium tetraisopropoxide were prepared at predetermined ratios and added to a propionic acid solution and mixed, and thereafter, the resulting mixture was heated to 140° C. for 120 minutes.

The thus obtained mixed liquid was coated on a Pt film (first electrode) having a thickness of 200 nm, followed by a heating treatment, whereby a pyroelectric body (pyroelectric layer) having a thickness of 400 nm was formed. The thus formed pyroelectric body was constituted by an oxide containing iron, manganese, bismuth, gadolinium, and titanium, and in the oxide, the ratio of the number of atoms of gadolinium to the total number of atoms of A-site elements was 16.0 at %, the ratio of the number of atoms of manganese to the total number of atoms of B-site elements was 1.0 at %, and the ratio of the number of atoms of titanium to the total number of atoms of B-site elements was 3.0 at %.

Thereafter, by performing sputtering in a state where a part of the stacked body of the first electrode and the pyroelectric body was masked with a polyimide tape, a Pt film (second electrode) having a thickness of 200 nm was formed on a part of the surface (the surface on the opposite side from the surface facing the first electrode) of the pyroelectric body.

### Examples 2 to 8

Stacked bodies each including a first electrode, a pyroelectric body, and a second electrode were produced in the same manner as in the above-mentioned Example 1 except that the blending ratios in the solution of the respective fatty acid metal salts used for preparing the mixed liquid were changed so that the pyroelectric body to be formed has the composition shown in Table 1.

### Comparative Examples 1 and 2

Stacked bodies each including a first electrode, a pyroelectric body, and a second electrode were produced in the same manner as in the above-mentioned Example 1 except that the blending ratios in the solution of the respective fatty acid metal salts used for preparing the mixed liquid were changed so that the pyroelectric body to be formed has the composition shown in Table 1.

### Comparative Example 3

A stacked body including a first electrode, a pyroelectric body, and a second electrode was produced in the same manner as in the above-mentioned Example 1 except that in the preparation of the mixed liquid, lanthanum acetate was used in place of gadolinium acetate, and the blending ratios of bismuth acetate, lanthanum acetate, iron acetate, manganese acetate, and titanium tetraisopropoxide were changed.

The compositions of the pyroelectric bodies of the above-mentioned respective Examples and Comparative Examples are summarized in Table 1. In Table 1, the ratio of the number of atoms of iron (Fe) to the total number of atoms of B-site elements in the oxide constituting the pyroelectric body is shown in the column headed “Fe ratio”, the ratio of the number of atoms of manganese (Mn) to the total number of atoms of B-site elements in the oxide constituting the pyroelectric body is shown in the column headed “Mn ratio”, the ratio of the number of atoms of titanium (Ti) to the total number of atoms of B-site elements in the oxide constituting the pyroelectric body is shown in the column headed “Ti ratio”, the ratio of the number of atoms of bismuth (Bi) to the total number of atoms of A-site elements in the oxide constituting the pyroelectric body is shown in the column headed “Bi ratio”, the ratio of the number of atoms of gadolinium (Gd) to the total number of atoms of A-site elements in the oxide constituting the pyroelectric body is shown in the column headed “Gd ratio”, and the ratio of the number of atoms of lanthanum (La) to the total number of atoms of A-site elements in the oxide constituting the pyroelectric body is shown in the column headed “La ratio”.

TABLE 1

| | Composition of pyroelectric body | | | | | |
|---|---|---|---|---|---|---|
| | Fe ratio | Mn ratio | Ti ratio | Bi ratio | Gd ratio | La ratio |
| | [at %] | [at %] | [at %] | [at %] | at %] | [at %] |
| Example 1 | 96.0 | 1.0 | 3.0 | 84.0 | 16.0 | — |
| Example 2 | 96.9 | 1.6 | 1.5 | 83.2 | 16.8 | — |
| Example 3 | 96.7 | 1.3 | 2.0 | 86.8 | 13.2 | — |
| Example 4 | 95.0 | 1.0 | 4.0 | 89.5 | 10.5 | — |
| Example 5 | 95.0 | 2.0 | 3.0 | 82.5 | 17.5 | — |
| Example 6 | 99.0 | 1.0 | 0 | 87.5 | 12.5 | — |
| Example 7 | 97.5 | 1.8 | 0.7 | 91.8 | 8.2 | — |
| Example 8 | 96.2 | 1.3 | 2.5 | 82.2 | 17.8 | — |
| Comparative | 0.9 | 4.1 | 95.0 | 92.2 | 7.8 | — |
| Example 1 | | | | | | |
| Comparative | 2.1 | 3.0 | 94.9 | 81.8 | 18.2 | — |
| Example 2 | | | | | | |
| Comparative | 97.5 | 1.8 | 0.7 | 78.0 | — | 22.0 |
| Example 3 | | | | | | |

### [2] Evaluation

### [2.1] Pyroelectric Coefficient

With respect to the above-mentioned respective Examples and Comparative Examples, by using a thermal stimulated current (TSC) measurement device (TS-POLAR, manufactured by Rigaku Corporation), the temperature was raised at a constant temperature raising rate from −50° C. to 50° C., and a value of an electric current generated at this time was measured. Then, from the measurement values, a pyroelectric coefficient at each temperature was determined, and evaluation was performed according to the following criteria.

A: The maximum pyroelectric coefficient is 110 nC/cm²·K or more.

B: The maximum pyroelectric coefficient is 100 nC/cm²·K or more and less than 110 nC/cm²·K.

C: The maximum pyroelectric coefficient is 60 nC/cm²·K or more and less than 100 nC/cm²·K.

D: The maximum pyroelectric coefficient is 50 nC/cm²·K or more and less than 60 nC/cm²·K.

E: The maximum pyroelectric coefficient is less than 50 nC/cm²·K.

### [2.2] Stability of Pyroelectric Coefficient

Based on the results of the above [2.1], the maximum value and the minimum value of the pyroelectric coefficient in the temperature range of −40° C. or higher and 40° C. or lower were determined, and evaluation was performed according to the following criteria.

A: The difference between the maximum value and the minimum value of the pyroelectric coefficient is less than 20 nC/cm²·K.

B: The difference between the maximum value and the minimum value of the pyroelectric coefficient is 20 nC/cm²·K or more and less than 30 nC/cm²·K.

C: The difference between the maximum value and the minimum value of the pyroelectric coefficient is 30 nC/cm²·K or more and less than 40 nC/cm²·K.

D: The difference between the maximum value and the minimum value of the pyroelectric coefficient is 40 nC/cm²·K or more and less than 50 nC/cm²·K.

E: The difference between the maximum value and the minimum value of the pyroelectric coefficient is 50 nC/cm²·K or more.

### [2.3] Measurement of Residual Polarization Amount (Electric Polarization Amount)

With respect to the above-mentioned respective Examples and Comparative Examples, by using an FCE ferroelectric evaluation system (manufactured by TOYO Corporation) and setting the measurement temperature to 25° C., a single-sided triangle wave with a peak voltage of −20 V was applied as a pre-waveform, and after 2 seconds, a standard triangle wave (+20 V→−20 V) with a peak voltage of 20 V was applied, and a residual polarization amount at this time was determined, and then, evaluation was performed according to the following criteria. Incidentally, the driving frequency was set to 1 kHz.

A: The residual polarization amount is 90 μC/cm²or more.

B: The residual polarization amount is 80 μC/cm² or more and less than 90 μC/cm².

C: The residual polarization amount is 70 μC/cm² or more and less than 80 μC/cm².

D: The residual polarization amount is 60 μC/cm² or more and less than 70 μC/cm².

E: The residual polarization amount is less than 60 μC/cm².

### [2.4] Measurement of Leakage Current (Evaluation of Insulating Property)

With respect to the above-mentioned respective Examples and Comparative Examples, a leakage current when a voltage was applied between the first electrode and the second electrode of the stacked body including the first electrode, the pyroelectric body, and the second electrode produced as described above was measured, and evaluation was performed according to the following criteria.

(When a voltage of 60 μV was applied)

A: The leakage current is less than 1.0E-10 A·cm².

B: The leakage current is 1.0E-10 A·cm² or more and less than 3.3E-10 A·cm⁻².

C: The leakage current is 3.3E-10 A·cm⁻² or more and less than 6.7E-10 A·cm².

D: The leakage current is 6.7E-10 A·cm² or more and less than 1.0E-9 A·cm².

E: The leakage current is 1.0E-9 A·cm⁻² or more.

### (When a Voltage of 12 V was Applied)

A: The leakage current is less than 1.2E-4 A·cm².

B: The leakage current is 1.2E-4 A·cm² or more and less than 1.2E-3 A·cm².

C: The leakage current is 1.2E-3 A·cm⁻² or more and less than 1.2E-2 A·cm².

D: The leakage current is 1.2E-2 A·cm² or more and less than 1.2E-1 A·cm².

E: The leakage current is 1.2E-1 A·cm² or more.

These results are summarized in Table 2.

TABLE 2

| | | Stability of | Residual | Evaluation of insulating property | |
|---|---|---|---|---|---|
| | Pyroelectric | pyroelectric | polarization | When applying | When applying |
| | coefficient | coefficient | amount | 60 μV | 12 V |
| Example 1 | A | A | A | A | A |
| Example 2 | A | A | A | A | A |
| Example 3 | A | A | A | A | A |
| Example 4 | A | B | A | A | A |
| Example 5 | A | B | A | B | A |
| Example 6 | A | B | A | C | A |
| Example 7 | B | B | C | C | A |
| Example 8 | B | B | C | A | A |
| Comparative | D | D | C | A | E |
| Example 1 | | | | | |
| Comparative | E | A | A | E | A |
| Example 2 | | | | | |
| Comparative | D | E | C | C | A |
| Example 3 | | | | | |

As apparent from Table 2, according to the invention, a pyroelectric body having a high pyroelectric coefficient (sensitivity) stably over a wide temperature range was obtained. On the other hand, in the case of Comparative Examples, a satisfactory result was not obtained.

The entire disclosure of Japanese Patent Application No. 2014-228304 filed Nov. 10, 2014 is expressly incorporated by reference herein.

What is claimed is:

1. A pyroelectric body, comprising an oxide containing iron, manganese, bismuth, and gadolinium, wherein
the oxide has a perovskite-type crystal structure, and
in the oxide, the ratio of the number of atoms of gadolinium to the total number of atoms of A-site elements is 8.0 at % or more and 18 at % or less.

2. The pyroelectric body according to claim 1, wherein in the oxide, the ratio of the number of atoms of manganese to the total number of atoms of B-site elements is 1.0 at % or more and 2.0 at % or less.

3. The pyroelectric body according to claim 1, wherein in the oxide, the ratio of the number of atoms of titanium to the total number of atoms of B-site elements is 0 at % or more and 4.0 at % or less.

4. The pyroelectric body according to claim 1, wherein the pyroelectric body is used at an environmental temperature in the range of −40° C. or higher and 40° C. or lower.

5. A pyroelectric element, comprising:
a first electrode;
the pyroelectric body according to claim 1; and
a second electrode.

6. A production method for a pyroelectric element, comprising stacking a first electrode, the pyroelectric body according to claim 1, and a second electrode.

7. A thermoelectric conversion element, comprising:
the pyroelectric element according to claim 5;
a light absorbing layer; and
an insulating layer provided between the pyroelectric element and the light absorbing layer.

8. A production method for a thermoelectric conversion element, comprising:
forming the pyroelectric element according to claim 5; and
forming a light absorbing layer through an insulating layer so as to cover at least a part of the pyroelectric element.

9. A thermal photodetector, comprising the pyroelectric element according to claim 5.

10. A thermal photodetector, comprising a pyroelectric element produced by using the production method according to claim 6.

11. A production method for a thermal photodetector, comprising:
preparing a base member having a substrate and a sacrifice layer;
forming a support member on a surface of the base member on a side where the sacrifice layer is provided;
forming the pyroelectric element according to claim 5 on the support member;
forming a light absorbing layer so as to cover an outer surface of the pyroelectric element through an insulating layer;
patterning the support member; and
etching the sacrifice layer.

12. An electronic apparatus, comprising the thermal photodetector according to claim 9.

13. An electronic apparatus, comprising the thermal photodetector according to claim 10.

14. An electronic apparatus, comprising a thermal photodetector produced by the production method according to claim 11.
